(19) United States
(12) Patent Application Publication
(10) Pub. No.: US 2023/0356091 A1
(43) Pub. Date: Nov. 9, 2023

(54) DYNAMIC NON-FUNGIBLE TOKENS REPRESENTING VIRTUAL CHARACTERS, OBJECTS AND LAND

(71) Applicant: ARTIE, INC., West Hollywood, CA (US)

(72) Inventors: Joshua Eisenberg, Los Angeles, CA (US); Armando McIntyre-Kirwin, Los Angeles, CA (US)

(21) Appl. No.: 18/189,656

(22) Filed: Mar. 24, 2023

Related U.S. Application Data
(60) Provisional application No. 63/364,183, filed on May 4, 2022.

(51) Int. Cl. A63F 13/71; A63F 13/60; G06Q 30/0601

(52) U.S. Cl. CPC A63F 13/71; A63F 13/60; G06Q 30/0643; G06Q 2220/00

(57) ABSTRACT

Virtual characters, objects, and land are represented by data associated with cryptographic tokens, such as non-fungible tokens (NFTs). The data is dynamically updated in response to conditions in the physical and virtual world. As a result, properties of the virtual characters, objects, and land, such as appearance, may change as reflected in a virtual environment and as propagated to other virtual environments that have access to the NFT. For example, a virtual character associated with a cryptographic token can be a user-controlled character in a software platform. As the virtual character interacts with various elements of the software platform, the information is appended to the data of the cryptographic token and updated in the other virtual environments that have access to the NFT.

### CROSS-REFERENCE TO RELATED APPLICATION(S)

This application claims the benefit of U.S. Provisional Patent Application No. 63/364,183, titled “DYNAMICALLY RESPONSIVE VIRTUAL CHARACTERS, OBJECTS, AND LAND” and filed May 4, 2022, which is incorporated herein by reference in its entirety.

### TECHNICAL FIELD

The disclosed teachings generally relate to interactions with dynamically responsive virtual characters, land, or objects.

### BACKGROUND

Virtual characters (or “avatars”) facilitate interaction with a user on a user device (e.g., a smartphone, computer, augmented reality device). Virtual characters may include virtual representations of a character depicted in an environment shown on a display of the user device. Virtual characters do not need to have a visual form. They just need to be able to communicate with a user through the user device. An input from the user may be identified and inspected to determine an action for the virtual character to take. The virtual character may take the determined action (e.g., perform an animation, speech), facilitating continued interaction between the virtual character and the user.

### BRIEF DESCRIPTION OF THE DRAWINGS

FIG. 1 illustrates an example virtual character displayed on a user device.

FIG. 2 illustrates an example virtual object.

FIG. 3 illustrates an example of virtual land. Virtual land is the virtual representation of land.

FIG. 4 is an example representation of a non-fungible token (NFT).

FIG. 5 is a block diagram illustrating a data structure of a smart contract.

FIG. 6 shows a system to store, update and distribute dynamic NFTs.

FIGS. 7A-7B are a flowchart of a method to store, update, and distribute dynamic NFTs.

FIG. 8 is a block diagram illustrating an example of a processing system in which at least some operations described herein can be implemented.

### DETAILED DESCRIPTION

Applicant of the present application owns U.S. patent application Ser. No. 17/596,262, titled “MULTI-MODAL MODEL FOR DYNAMICALLY RESPONSIVE VIRTUAL CHARACTERS” and filed on Dec. 6, 2021; PCT application No. PCT/US2020/036068, titled “MULTI-MODAL MODEL FOR DYNAMICALLY RESPONSIVE VIRTUAL CHARACTERS” and filed Jun. 4, 2020; and U.S. provisional patent application No. 62/858,234, titled “MULTI-MODAL MODEL FOR DYNAMICALLY RESPONSIVE AVATARS” and filed Jun. 6, 2019. The disclosures of each of the preceding documents are herein incorporated by reference in their entirety.

One facet of the present application is representing virtual characters, objects, and land by data associated with cryptographic tokens, such as non-fungible tokens (NFTs). The data is dynamically updated in response to conditions in the physical and virtual world. As a result, properties of the virtual characters, objects, and land, such as appearance, may change as reflected in a virtual environment and as propagated to other virtual environments that have access to the NFT. For example, a virtual character associated with a cryptographic token can be a user-controlled character in a software platform. As the virtual character interacts with various elements of the software platform, the information is appended to the data of the cryptographic token and updated in the other virtual environments that have access to the NFT

Another facet of the present application is blockchain-based technology. A blockchain is a continuously growing list of records, called blocks, which are linked and secured using cryptography. Each block may contain a hash pointer as a link to a previous block, a timestamp, and transactional data (e.g., each block may include many transactions). By design, a blockchain is inherently resistant to modification of already-recorded transactional data (i.e., once a block is appended to the blockchain, it cannot be changed). Additional blocks may be appended to a blockchain, where each additional block (i.e., “change”) may be recorded on the blockchain. A blockchain may be managed by a peer-to-peer network of nodes (e.g., devices) collectively adhering to a consensus protocol for validating new blocks. Once recorded, the transaction data in a given block cannot be altered retroactively without the alteration of all previous blocks, which requires collusion of a majority of the network nodes.

Although originally developed for transactions of currency, blockchains can be used to support transactions of other types, such as those relating to the sale of vehicles, sale of financial derivatives, sale of stock, payments on contracts, and so on. For example, an NFT can uniquely identify something that can be owned. An NFT for a physical or digital asset can be generated using a cryptographic one-way hash of information that uniquely identifies the asset. The creation of an NFT for an asset in a blockchain establishes provenance of the asset, a process referred to as “minting.” The NFT can be used in transactions (e.g., buying, selling, insuring, securing obligations) involving the asset stored in a blockchain, creating a full audit trail of the transactions.

Smart contracts enable more complex transactions. A smart contract is computer code that implements transactions of a contract. The computer code may be executed in a secure platform (e.g., an Ethereum platform, which provides a virtual machine) that supports recording transactions in blockchains. In addition, the smart contract itself is recorded as a transaction in the blockchain using an identity token that is a hash (i.e., identity token) of the computer code so that the computer code that is executed can be authenticated. When deployed, a constructor of the smart contract executes, initializing the smart contract and its state. The state of a smart contract is stored persistently in the blockchain. When a transaction is recorded against a smart contract, a message is sent to the smart contract, and the computer code of the smart contract executes to implement the transaction (e.g., debit a certain amount from the balance of an account). The computer code ensures that all the terms of the contract are complied with before the transaction is recorded in the blockchain.

An NFT is a non-interchangeable unit of data stored on a blockchain, a form of digital ledger. Typically, the data in an NFT is static: once it is created, the primary data and metadata do not change. An NFT is owned when an entity (e.g., a person or corporation) has the specific NFT stored in its cryptocurrency address.

Introduced are techniques for implementing dynamic NFTs. A dynamic NFT is an NFT with metadata or primary data that is dynamically updated based on different conditions. The disclosed techniques apply to both changes to primary data and changes to metadata. In terms of causes of these changes, causes can originate from both the physical/real world or from the virtual world.

The dynamic NFTs described in this document include three types of NFT: virtual character, virtual land, and virtual objects. These three types of NFT are very different from each other, and therefore their behavior varies greatly when implemented as dynamic NFTs.

The metadata and primary data can be stored in multiple ways. For instance, data could be stored on-chain, in an Interplanetary File System (IPFS), or some other server-based storage system. The technology disclosed in this document can be applied to any of these storage systems because: 1) methods could be built into the NFT's smart contract that allow either the metadata or primary data to be altered on-chain or 2) the NFT creator can alter the metadata or primary data if that data is stored off-chain on a server pointed to via a uniform resource identifier (URI).

The dynamic NFTs can be minted on different blockchains. Although the technology is mostly described in this document in the context of the Ethereum blockchain, other blockchains can be used, such as Bitcoin, Cardano, Solana, etc.

Disclosed are techniques for interacting with dynamically responsive virtual characters, objects, or land represented on a device that receives input from the user operating the device. The virtual characters, object, or land also respond based on information recorded on a blockchain, as well as information sources referenced by locations recorded on a blockchain (e.g., a file system). Thus, a “device” may refer to a user device, such as a phone, or a collection of devices that operate a virtual machine (e.g., the Ethereum Virtual Machine (EVM)).

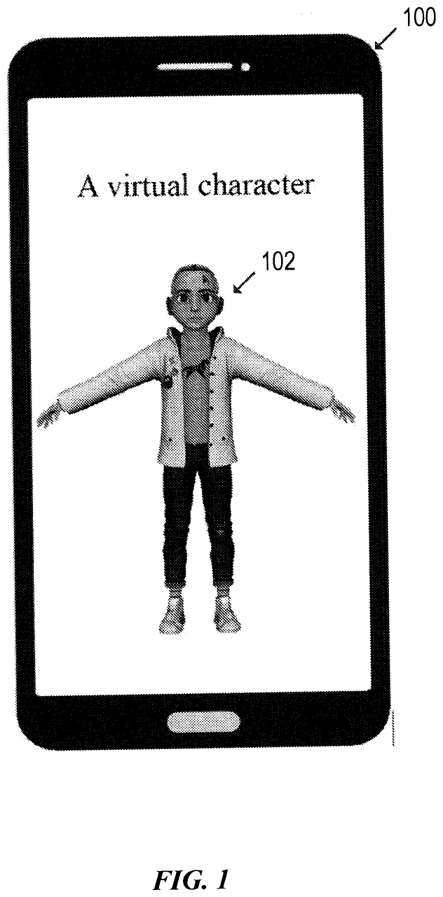

FIG. 1 illustrates an example virtual character 102 displayed on a user device 100. Virtual characters are generally animate. A virtual character can be an object with animacy. A virtual character may include a virtual representation of an animate entity, such as a representation of a real human, a fictional human, or an imaginary character, like a space alien, or a talking dog. The virtual character can be seen on a computer screen or displayed on another device. The virtual character may have a representation of a body that is animated on the screen. A virtual character does not need to appear visually; it could just present itself as a voice. It could also just communicate via texts (chat), or images.

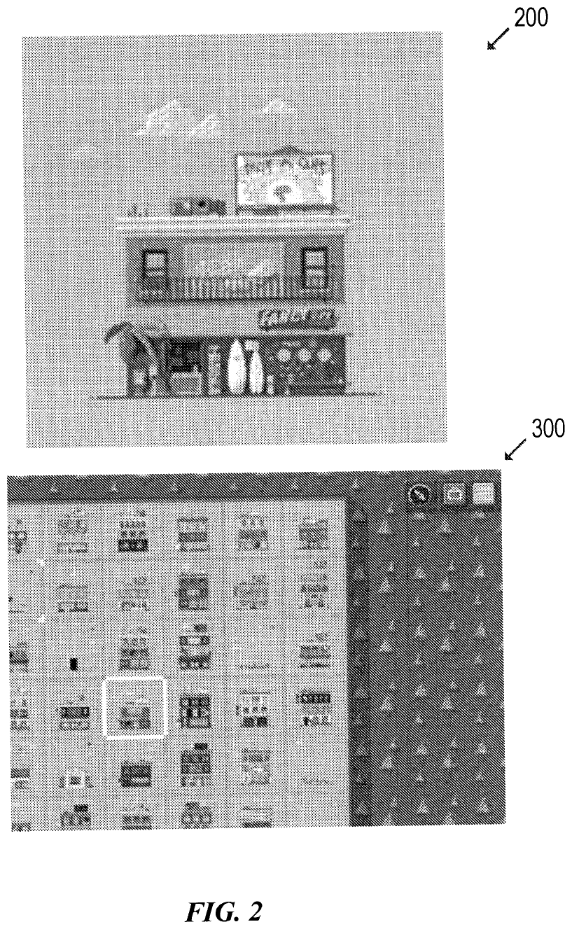

FIG. 2 illustrates an example virtual object. Virtual objects are virtual representations of objects. Objects are tangible or material things that occupy physical space. An object is inanimate. Animacy is defined by Jahan, et al., as “the characteristic of being able to independently carry out actions” (e.g., movement, communication, etc.). For example, people or birds are animate because they move or communicate under their own power. On the other hand, a chair or a book is inanimate because it does not perform any kind of independent action.” Labiba Jahan, Geeticka Chauhan, and Mark Finlayson, 2018, A New Approach to Animacy Detection, in Proceedings of the 27th International Conference on Computational Linguistics, pages 1-12, Santa Fe, New Mexico, USA, Association for Computational Linguistics.

In this document, animate objects are considered virtual characters. If an entity is animate, then it has the necessary properties to be a virtual character. For example, a talking calculator that can exert its will on the world by talking and acting is a virtual character. However, an inanimate calculator is just a virtual object.

In some implementations, a virtual character is able to use a virtual object or own a virtual object. A virtual object can be stored in or stored on virtual land. It is possible for a virtual object to own virtual land.

Virtual objects can range from anything as mundane as dirt, a quantity of grain, a cast-iron skillet, or chicken eggs, to more exciting objects, such as a Porsche 911® Turbo, a palm tree, or a wheel of parmesan cheese.

A building or a structure can be considered a virtual object. The building in the abstract is an object. However when the building is placed in a specific location, it becomes one with the virtual land. For example, the building 200 is a tiki bar with an apartment above it. The building 200 is a virtual object. Once the building 200 is placed on land (e.g., virtual land), it becomes part of that land until it is removed from the land. As shown, the building 200 is placed at the coordinate of [32,32] on the Euclidean Turf grid 202.

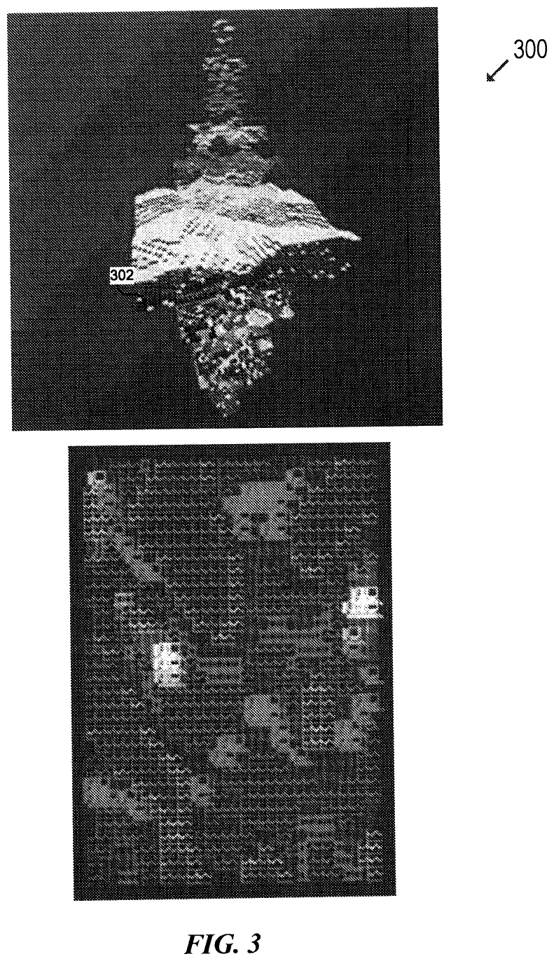

FIG. 3 illustrates an example of virtual land. Virtual land is the virtual representation of land. Virtual land is inanimate. However, the things on the land may be animate. For example, virtual characters can be on virtual land. Virtual objects can be on or stored at virtual land. Buildings, which are virtual objects, can be placed on virtual land, as seen on the Turf grid in FIG. 2. Turf is a 2D world, where the land is divided up into 2D squares on a plane.

However, not all virtual worlds have to be two-dimensional. For example, Mathcastles (also known as Terraforms) is a three-dimensional world. It can also be represented as a four-dimensional world (three spatial dimensions, plus one time-based dimension), because the topology of the world changes over time.

Rendering 300 is a 3D rendering of the full hyper-castle structure of about 10,000 Mathcastles. It is a 3D structure that has 20 levels. Each level is made up of a matrix of plot. An example of a plot is shown as plot 302. (source: terraform #328 https://opensea.io/assets/0x4e1f41613c9084fdb9e34e11fae9412427480e56/328). Each plot is a 3D structure, and each text character (like the computer and graph shapes in the plot) in the plot represents a height. The plot 302 shown in FIG. 3 is merely a representation of the data. There is no canonical or correct rendering, just as there is no correct reference frame for the universe. The land in Mathcastles' world is laid out in 3D space, unlike Turf, which is on a 2D plane. This example demonstrates that the scope of what is considered land is not limited to a conventional understanding of land or space. “Land” can reside in any number of dimensions similar to hyper-dimensional spaces in classical mathematics.

Land is space that can be occupied. Virtual land can be occupied by virtual objects and virtual characters. Virtual land can be owned by real people or virtual people. Virtual land can also be owned by groups of people (e.g., corporations). Virtual land is the virtual representation of land. A virtual character may be owned by any entity {e.g., a person, group, entity, corporation, decentralized autonomous organization (DAO), etc.). A virtual character is owned by a person (or other entity) if that person owns the NFT that represents that specific virtual character.

Land can contain virtual objects that are themselves NFTs within the land. For example, a plot of land might be minted, where the land contains 50 tokens of raw iron ore and a farm house building. The iron ore and the building are both virtual objects that exist on the land.

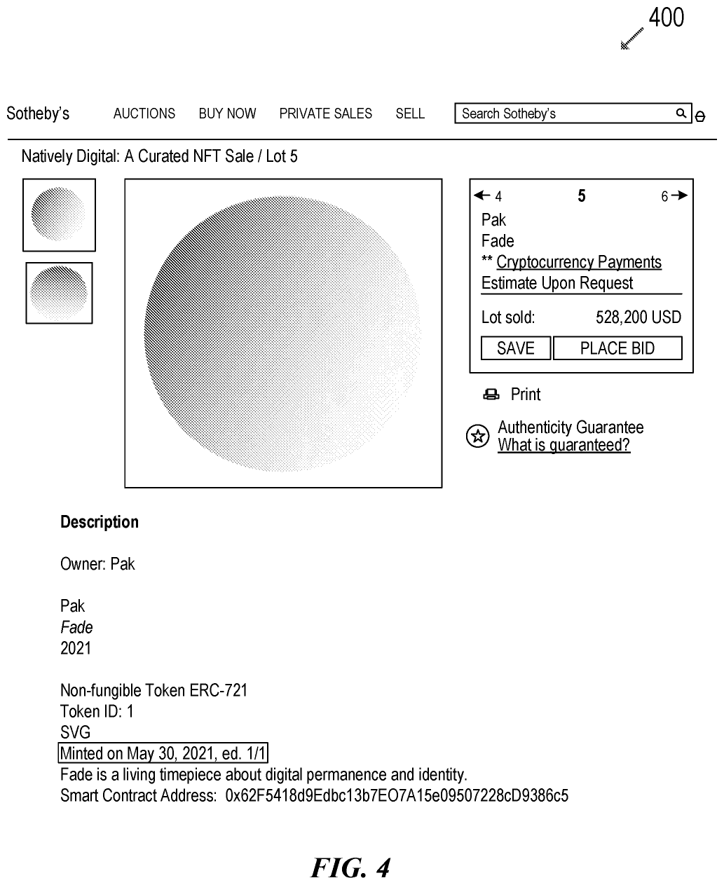

FIG. 4 is an example representation of an NFT 400. Ownership of an NFT begins when an NFT is sent to a person's cryptocurrency address. The ownership is sustained for the length of time that the NFT is held at that person's cryptocurrency address. The ownership is terminated when the NFT is sent to a different cryptocurrency address (i.e., the NFT is no longer located the original person's cryptocurrency address).

At any point in time, an NFT can only be stored at one location. The locations which NFTs are located at are cryptocurrency addresses. Typically, NFTs are stored at Ethereum addresses, however, NFTs can be stored at many different types of cryptocurrency addresses.

### Dynamic Virtual Characters

Virtual characters can be represented by NFTs. Ownership of an NFT representing a character does not necessarily grant intellectual property rights of the underlying character to the NFT's owner. Such IP rights can be determined by the license the NFT was sold under. This license is typically permanently and immutably stored, or referenced to, in the metadata that the NFT was given when it was initially minted. However, it is also possible for a contract owner to change an NFT's license as time progresses.

The following concepts can be used in relation to virtual characters: dynamic NFT, dynamic character, dynamic NFT character, interactive NFT, interactive character, interactive NFT character, crypto collectible character, interactive crypto collectible, crypto collectibles, and dynamic crypto collectibles.

Each virtual character that has is associated with an NFT is a unique entity. In the fine art world, this is referred to as an original or a unique work. Typically these NFTs are implemented using the ERC-721 standard (https://eips.ethereum.org/EIPS/eip-721). However, NFTs can also be implemented using the ERC-1155 standard (https://eips.ethereum.org/EIPS/eip-1155). A unique work is known as a “1 of 1” or a “1/1,” which is a reference to the size of an edition in printmaking. [See, e.g., https://www.sothebys.com/en/buy/auction/2021/natively-digital-a-curated-nft-sale-2/to-be-announced].

When virtual characters are represented as NFTs, they are original. This is different than classical implementations of virtual characters, especially in the medium of video games. Take, for example, the character Mario from the Super Mario® series of video games (e.g., Super Mario 64® for the Nintendo 64® video game console). Millions of copies of Super Mario 64 have been sold, each with many copies of the Mario virtual character. Each game contains geometric renderings of what the character Mario looks like (e.g., stored in game cartridge memory). However, none of the people who own the game Super Mario 64 own a unique Mario. Every copy of the virtual character Mario is just a copy. Additionally, users who buy the cartridge containing the software for Super Mario 64 have no ownership over the characters in the game.

In contrast, if a virtual character has its ownership determined by an NFT, the owner of the NFT, if prescribed by the NFT's license, can own the idea of the character (i.e. the virtual character), the character's geometry, appearance, and other elements or rights.

When a virtual character is associated with an NFT, it can be original. Information about what happens to this character can be added to the metadata of the NFT. This process can happen manually (by the intervention of the owner) or through automated processes (i.e. dynamically). These dynamic or automated processes include, but are not limited to, the following processes.

1. When the virtual character associated with an NFT is being used in a video game, the software for the video game can add metadata to the character's NFT. For example:
When the character levels up, level information is appended to the metadata of the NFT. Thus, that the character has reached the new level is verifiable via the public ledger.
The character gains experience points. Similar to leveling up, experience points can be recorded.
The character wins a match. The win is recorded to the NFT's win/loss ratio so that others can verify the character's performance at the type of match.

2. When the virtual character is used for some type of virtual interaction. For example:
The virtual character attends a virtual concert or event. The virtual character can earn a token that proves that the virtual character attended the concert or event. This is automatically added to the NFT's metadata.
Proof of Attendance Protocol (POAP) tokens can be appended to the NFT's metadata to verify that the virtual character was at an event or performed a specific action.

3. Artificial intelligence (AI) systems can append information to the metadata for the virtual character. For example:
An AI or Natural Language Understanding (NLU) or Natural Language Generation (NLG) system can automatically read information about the history of virtual character.
AI and NLU systems can be used to analyze the metadata of an NFT for a virtual character. These systems can then decide to make new additions to the NFT metadata based on their computational understanding of the original metadata. For example:
   An NFT can include a series of plain text sentences that tell a story of what has happened to the NFT's virtual character since it was originally minted.
   “Dynamic Lore” refers to a concept of a dynamic narrative. Dynamic Lore tells the story of virtual characters as they progress through their existence. Dynamic Lore can be both written by humans or AI systems.
   An NLU pipeline can extract feature vectors which encode some understanding of what has happened in the character's story. These features can include but are not limited to: the main character's emotional state, relationships between the main character and other characters, narrative point of view, narrative diegesis, identification of main events, identification of important characters, etc. These feature vectors can then be used downstream by other algorithmic (e.g., AI or classical computational) systems that use the encoded information to determine the next sentence written for the character's story.

4. Automated abuse prevention or detection systems can append information to the metadata of an NFT associated with a virtual character.
If a person owns an NFT of a virtual character, an automated system can detect that the owner is spamming other users, sending other users explicit messages, participating in hate crimes, cheating at the game, not following terms of service, stealing, or otherwise performing abusive or problematic activities. The automated system can then attach tokens which represent specific incidents of abuse/violations. These abuse/violation tokens can then be used by other automated systems to either suspend or ban bad actors/users or their associated characters from accessing game systems or interacting with other users.

In some implementations, NFT metadata can also be modified manually. Some examples of manual NFT metadata intervention include:
The owner adding a name associated with the NFT
The owner adding a short biography associated with the NFT
The owner appending other NFTs to the virtual character's NFT. For example:
   The owner can own a compatible NFT of a virtual object, such as a pair of green sunglasses. The object's NFT can be appended to the virtual character's NFT, such that the virtual character may wear the pair of green sunglasses.
   The owner can write a story about the character and add the story to the NFT.
   The owner can create or obtain art of the character and add the art to the NFT. For example, the original character art may be a 2D rendering of the character, but the new art is 3D. The virtual character can then be updated to use the new 3D art.
   The owner can obtain or make music for the character and add the music (e.g., as the character's theme song). The music may then be used in a virtual environment (e.g., a game), which automatically plays the music whenever the character arrives in a new space.

Additionally, mechanics that are used in video games can be applied to dynamic virtual NFT characters. For example:
An NFT that represents a virtual character can be used in a video game. The actions of that character in the video game world affect the metadata of the NFT of the character on the blockchain. For example:
   An NFT character is used for a video game where players race against each other. Each time a character wins a race, the character gains a certain number of experience points that are stored in a field the NFT's metadata. This experience can be used to determine the character's level, which then can be used in the game to affect game play (for example, characters with a higher level can have faster acceleration when racing).
   The visual or primary data can also change. As characters gain experience, their appearance can change. For example, a character may grow hair when the character accumulates one million experience points.

Dynamic traits can also be applied to items in a game. For example:
Items can also have dynamic metadata. For an NFT item of a sword, the sword can be used by a character for over a 100 hours of game play, at which point the sword becomes a glowing sword that deals twice as much damage as the original sword. The glowing sword is still represented by the same NFT, but its metadata has changed to reflect the updates. In this regard, this is similar to the experience and leveling system described above for virtual characters.
Another example of an item with dynamic traits are item containers. For example, a pill bottle can contain five healing pills. If a character uses a healing pill, then four healing pills remain. The total pills in the bottle can be stored as a field of the metadata.

Virtual land can be configured with dynamic traits using dynamic NFTs. For example, when land is minted, it can start off with specific resources. Consider this illustrative example:
A plot of virtual land is minted as an NFT.
On the virtual land are resources that can be represented in the metadata properties of the land. For example,
   There are 500,000 gallons of water on the land.
   There are 20,000 kilograms of iron ore on the land.
   There are 329 chickens on the land.
   There are 259 roosters on the land.
The quantities of these resources can change over time. For example:
   A virtual character (e.g., controlled by a player, computer, or a non-playable character) can harvest the iron ore on the land. This decreases the amount of iron ore on the land. The iron ore can be used to create items like swords.
   There may be a rainstorm on the virtual land in which 5,000 gallons of rain get deposited. The new total amount of water on the land is 505,000 gallons.
Human customers, computer programs, or non-playable characters (NPCS) may place items on the land or alter the land. For example:
   Virtual buildings can be placed on the land.
   Items can be stored on the land.
   The topology of the land can be altered or terraformed by those who have the rights.

Dynamic NFTs, regardless of type, can also have their metadata updated by more than just one source, such as an ecosystem of video games or any other system that can interact with the blockchain (e.g., NFT marketplaces). In this situation, the blockchain can record dynamic changes to the metadata via the blockchain's timestamp function. For example, a video game character owned by a player can appear within two or more video games at the same time, and if the character dies in the first game, the character is also shown as dead in the second game. Another example is a plot of virtual land where the player wins a tournament and receives a virtual castle for that land, while the player also makes a purchase at an NFT marketplace to add a virtual farm to be next to the castle on the virtual land. In this case, the dynamic NFT can be updated to reflect both the castle and the land.

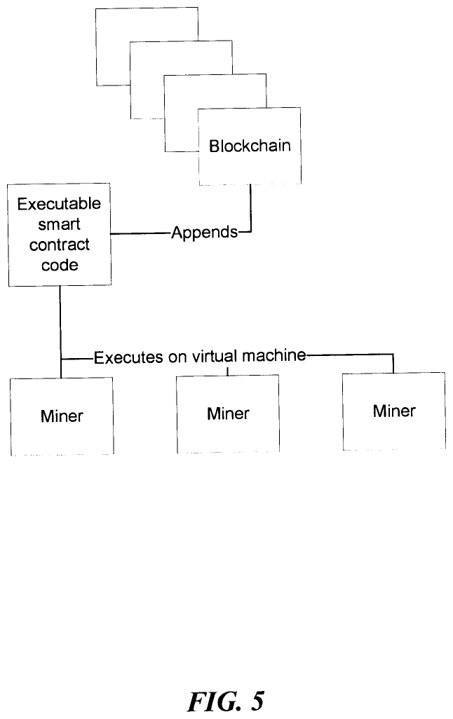

FIG. 5 is a block diagram illustrating a data structure of a smart contract. Smart contracts and decentralized applications (dApps) execute on an EVM. The EVM is instantiated on available network nodes. Smart contracts and dApps are applications that execute; thus, the processing power to do so must come from hardware somewhere. Nodes must volunteer their processors to execute these operations based on the premise of being paid for the work in Ethereum coins, referred to as Ether, measured in “gas.” Gas is the name for a unit of work in the EVM. The price of gas can vary, often because the price of Ether varies, and is specified within the smart contract/dApp.

Every operation that can be performed by a transaction or contract on the Ethereum platform costs a certain amount of gas, with operations that require more computational resources costing more gas than operations that require few computational resources. For example, at the time of writing, a multiplication instruction requires five gas, whereas an addition instruction requires three gas. Conversely, more complex instructions, such as a Keccak256 cryptographic hash requires 30 initial gas and six additional gas for every 256 bits of data hashed.

The purpose of gas is pay for the processing power of the network on execution of smart contracts at a reasonably steady rate. That there is a cost at all ensures that the work/processing being performed is useful and valuable to someone. Thus, the Ethereum strategy differs from a Bitcoin transaction fee, which is only dependent on the size in kilobytes of a transaction. As a result that Ethereum's gas costs being rooted in computations, even a short segment of code can result in a significant amount of processing performed. The use of gas further incentivizes coders to generate efficient smart contracts/algorithms. Otherwise, the cost of execution may spiral out of control. Unrestricted, an exponential function may bankrupt a given user.

While operations in the EVM have a gas cost, gas has a “gas price” measured in Ether. Transactions specify a given gas price in Ether for each unit of gas. The fixing of price by transaction enables the market to decide the relationship between the price of Ether and the cost of computing operations (as measured in gas). The total fee paid by a transaction is the gas used multiplied by gas price.

If a given transaction offers very little in terms of a gas price, that transaction will have low priority on the network. In some cases, the network miners may place a threshold on the gas price for which each is willing to execute/process. If a given transaction is below that threshold for all miners, the process will never execute. Where a transaction does not include enough Ether attached (e.g., because the transaction results in so much computational work that the gas costs exceed the attached Ether) the used gas is still provided to the miners. When the gas runs out, the miner will stop processing the transaction, revert changes made, and append to the blockchain with a “failed transaction.” Failed transactions may occur because the miners do not directly evaluate smart contracts for efficiency. Miners will merely execute code with an appropriate gas price attached. Whether the code executes to completion or stalls out due to excessive computational complexity is of no matter to the miner.

Where a high gas price is attached to a transaction, the transaction will be given priority. Miners will process transactions in order of economic value. Priority on the Ethereum blockchain works similarly as with the Bitcoin blockchain. Where a user attaches more Ether to a given transaction than necessary, the excess amount is refunded back to that user after the transaction is executed/processed. Miners only charge for the work that is performed. A useful analogy regarding gas costs and price is that the gas price is similar to an hourly wage for the miner, whereas the gas cost is like a timesheet of work performed.

A type of smart contract that exists on the Ethereum blockchain is ERC-721 tokens (Ethereum Request for Comment-721). ERC-721 is a technical specification for NFTs. The ERC-721 introduces a standard for NFTs. An ERC-721 token is unique and can have different exclusivity to another token from the same smart contract, maybe due to age, rarity or visuals.

ERC-721 defines a common list of rules for Ethereum tokens to follow within the larger Ethereum ecosystem, allowing developers to accurately predict interaction between tokens. These rules include how the tokens are transferred between addresses and how data within each token is accessed. ERC-721 provides a framework for a means to build a token on top of a base cryptocurrency. In some embodiments herein, enhancements are built on top of the ERC-721 framework, though use of the ERC-721 technical specification is not inherently necessary and is applicable to circumstances where Ethereum is used as the base cryptocurrency.

NFTs have a uint256 variable called tokenId. Thus, for any ERC-721 contract, the pair contract address, uint256 tokenId, must be globally unique. That said, a given dApp can have a “converter” that uses the tokenId as input and outputs an image. The image associated with an NFT is generally specified in the smart contract or dApp that mints the NFT.

Disclosure on token protocols has focused on Ethereum. As applicable in this disclosure, Ethereum is a base cryptocurrency. Other base cryptocurrencies exist now and in the future. This disclosure is not limited to application on specifically the Bitcoin or Ethereum blockchains.

In some embodiments, each NFT associated with the same particular artwork is minted by executing smart contracts that share the same functional code, resulting in each owner of the NFTs having the same access permissions. For example, executing smart contracts coded with the same event permissions enables each owner to access group events associated with the particular artwork, such as social activities and parties in a virtual reality (VR) metaverse. In some embodiments, a group of NFTs, such as those associated with a group of paintings housed by the same museum, are granted similar privileges. For example, all owners of NFTs associated with the same museum can then attend a virtual fundraiser for the museum.

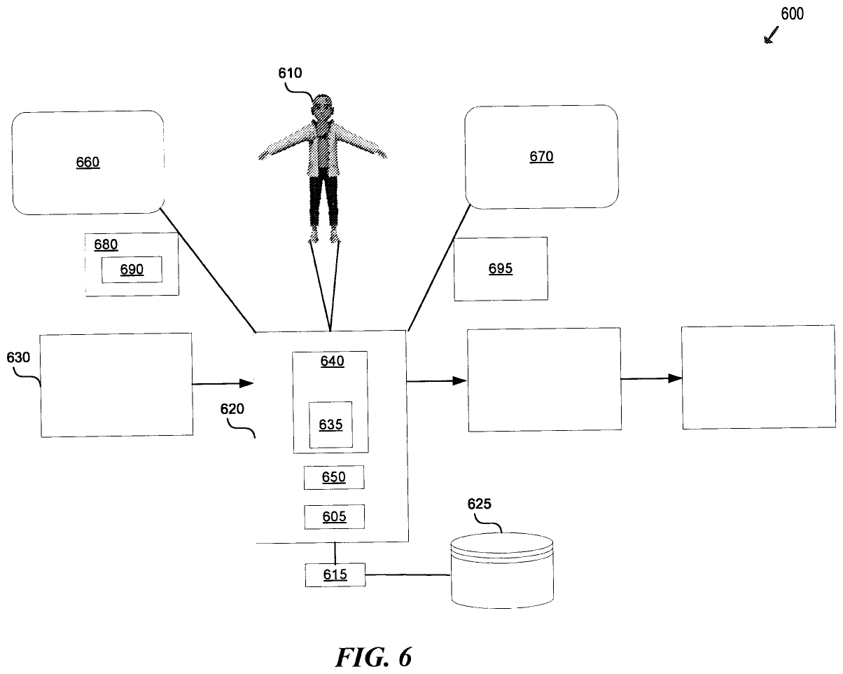

FIG. 6 shows a system to store, update, and distribute dynamic NFTs. The system 600 can store a virtual element 610, such as a virtual character or a virtual object as an NFT 620 in a blockchain 630. The NFT 620 can include metadata 640 which can include virtual element 610's attributes 635 such as size, color, accessories, rewards, skills, location, boundaries, etc. depending on the type of the virtual element 610. In addition, the NFT 620 can include a first authorization token 650, which directly or indirectly identifies users that can modify the NFT 620, such as modifying the NFT's metadata 640.

The virtual element 610 can appear in multiple software platforms 660, 670 (only two shown for brevity) such as different video games, NFT marketplaces, social media, or software platforms that can interact with the blockchain 630. The system 600 can receive a request 680 to update (e.g., modify) the virtual element 610. The request 680 can include a second authorization token 690. The system 600 can authorize the request 680 by determining whether the first authorization token 650 and the second authorization token 690 correspond to each other. Upon determining that the tokens 650, 690 correspond to each other, the system can make the update to the virtual element 610.

To make the update based on the request 680, the system can include a timestamp 605 of when the update is made and store the timestamp 605. The system 600 can store the timestamp 605 inside the dynamic NFT 620 or the dynamic NFT can include a link 615 to an off-chain database 625 which can include the modifications and the corresponding timestamps 605. In addition, the system can send the update 695 to the remaining software platforms 670 which have not received the update.

For example, the virtual element 610 can be a video game character that can appear in multiple video games 660, 670 at the same time. A player can own the video game character 610 and play with the character and in multiple video games 660, 670. If the character 610 dies in the first game 660, the system 600 can also cause the second game 670 to show the character as dead.

In another example, the virtual element 610 can be a plot of virtual land where the player wins a tournament and receives a virtual castle for that land. The player also can make a purchase at an NFT marketplace to add a virtual farm to be next to the castle on the virtual land. In this case, the system 600 can update the dynamic NFT 620 to reflect both the castle and the farm.

In one embodiment, to determine whether the tokens 650, 690 correspond to each other, the token 650 can be a password, and the system 600 can determine whether the two passwords 650, 690 match. In another embodiment, the token 650 can include one or more public cryptographic keys associated with one or more users authorized to make modifications to the NFT 620. The token 690 can be a cryptographic signature of a user making the request 680. The cryptographic signature can be the request signed with the private key of the requesting user. The system 600 can determine whether the cryptographic signature 690 is valid by decrypting the cryptographic signature 690 using each public cryptographic key stored in the token 650, until a sensical name or a sensical request is decrypted from the cryptographic signature 690. If the cryptographic signature 690 does not match any of the public cryptographic keys stored in the token 650, the decryption will provide a garbled string of characters. However, if the cryptographic signature 690 matches one of the cryptographic keys stored in the token 650, the decryption will provide a sensical name and/or a sensical request. Consequently, if the system 600 authorizes the request 680 by obtaining a sensical name and/or a sensical request, the system can modify the metadata 640 and send the update 690 to the rest of the platforms.

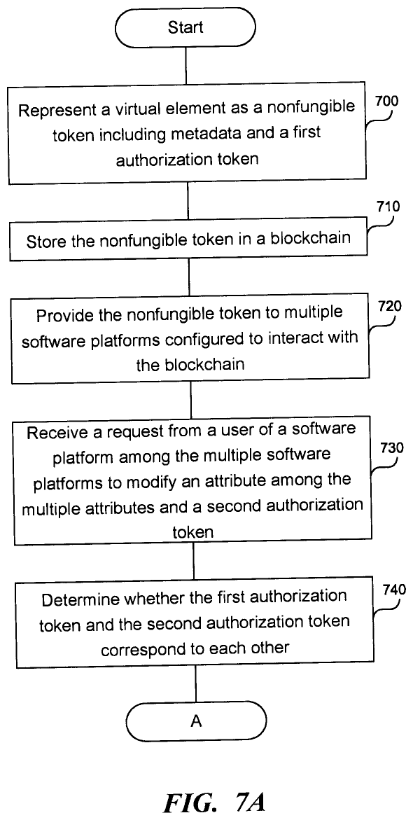

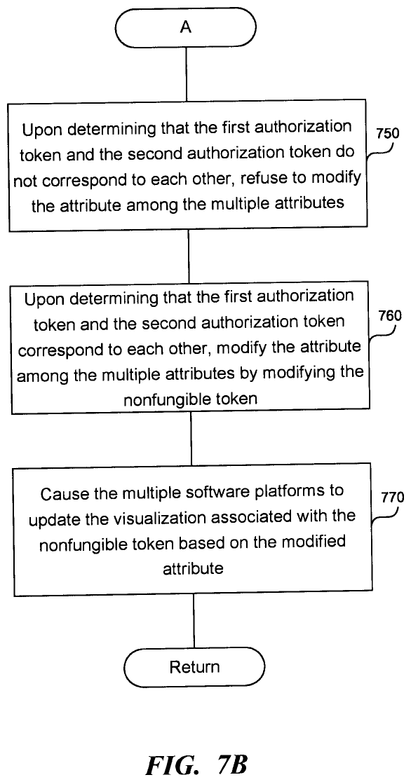

FIGS. 7A-7B are a flowchart of a method to store, update and distribute dynamic NFTs. A hardware or software processor, executing instructions described in this application, in step 700 can represent a virtual element as an NFT including metadata and a first authorization token. The virtual element can include a character, an object, an environment, a landscape, etc. in a virtual world such as the metaverse. The authorization token can be a password or a secret encrypted using public key cryptography. There can be multiple authorization tokens associated with multiple users authorized to modify the virtual element. The metadata can include one or more attributes associated with the virtual element, where the one or more attributes are modifiable.

In step 710, the processor can store the NFT in a blockchain. In step 720, the processor can provide the NFT to multiple software platforms configured to interact with the blockchain, thereby causing the multiple software platforms to generate a modification associated with the NFT. The modification can include directly or indirectly cause a sensory modification such as a visual modification, an audio modification, a haptic modification, an olfactory modification, a flavor modification.

In step 730, the processor can receive a request to modify an attribute among the one or more attributes and a second authorization token. The request can be generated by the user or by a software platform interacting with the user. In step 740, the processor can determine whether the first authorization token and the second authorization token correspond to each other.

In step 750, the processor, upon determining that the first authorization token and the second authorization token do not correspond to each other, can refuse to modify the attribute among the one or more attributes.

In step 760, upon determining that the first authorization token and the second authorization token correspond to each other, the processor can modify the attribute among the one or more attributes by modifying the NFT. The processor can store the attribute and the modification on the same blockchain as the token, or in a database stored off the blockchain.

In step 770, the processor can cause the multiple software platforms to update the modification associated with the NFT based on the modified attribute. The multiple software platforms can make the update in real time or, at most, with several seconds delay from making the modification on the blockchain.

Upon determining that the first authorization token and the second authorization token correspond to each other, the processor can determine a time associated with modifying the NFT. Based on the time, the processor can create a timestamp associated with modifying the NFT. The processor can record the timestamp in the original NFT. Alternatively, the processor can record the timestamp in a different NFT with an ID corresponding to the original NFT.

The processor can receive an indication that the virtual character has died in a first software platform among the multiple software platforms. The processor can modify the NFT to indicate that the virtual character has died. The processor can cause a second software platform among the multiple software platforms to indicate that the virtual character is dead. Similarly, if the character has a new weapon, or a new skill, has won a tournament and/or received a trophy, the processor can modify the NFT to indicate the change, and can cause other software platforms to update the character appearance and/or character attributes.

The processor can receive an indication that a user in a first software platform purchased a second NFT from an NFT marketplace, where the second NFT modifies the NFT. The processor can modify the NFT based on the second NFT. The processor can cause a second software platform among the multiple software platforms to display a modification associated with the second NFT. For example, the user can own a plot of virtual land. If the user wins a tournament and receives a virtual castle for that land, while the user also makes a purchase at an NFT marketplace to add a virtual farm next to the castle on the virtual land, the virtual farm can be represented by the second NFT. In this case, the processor can update the dynamic NFT to reflect both the castle and the farm.

The first authorization token can include a password. The first authorization token can include multiple authorization tokens associated with multiple users authorized to modify the virtual element. To determine whether the first authorization token and the second authorization token correspond to each other, the processor can determine whether the second authorization token matches the password.

The first authorization token can include multiple authorization tokens corresponding to multiple users authorized to modify the virtual element. For example, the processor can obtain multiple identifiers indicating multiple entities authorized to modify the NFT, where the multiple identifiers include multiple public cryptographic keys associated with the multiple entities. The processor can receive the second authorization token including a cryptographic signature associated with the user. The processor can determine whether the first authorization token and the second authorization token correspond to each other by determining whether a public cryptographic key among the multiple public cryptographic keys corresponds to the cryptographic signature associated with the user. To determine whether the first and the second authorization token correspond to each other, the processor can determine whether the public cryptographic key can decrypt the cryptographic signature and obtain a sensical name. Upon determining that the public cryptographic key corresponds to the cryptographic signature associated with the user, the processor can authenticate the user, thus allowing the user to modify the NFT.

The processor can obtain multiple identifiers indicating multiple entities authorized to modify the NFT. The processor can receive the second authorization token including a cryptographic signature associated with the user, where the cryptographic signature can be a dictionary word or multiple words encrypted using a private key of the user trying to modify the NFT. The processor can determine whether the first authorization token and the second authorization token correspond to each other by determining whether the identifier among the multiple identifiers corresponds to the cryptographic signature associated with the user. In other words, the processor can decrypt the second token using a public key associated with each of the multiple entities, until a dictionary word is obtained, or until decryption using any of the public keys produces a sensical dictionary word. Upon determining that the identifier corresponds to the cryptographic signature associated with the user, the processor can authenticate the user.

### Computer System

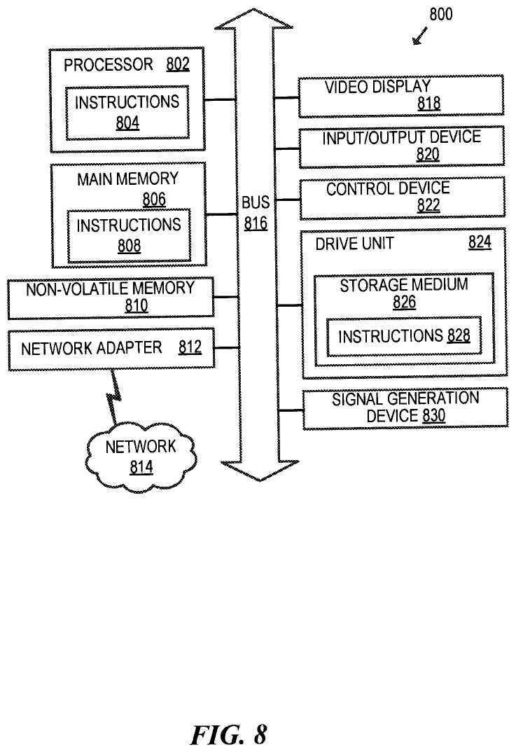

FIG. 8 is a block diagram illustrating an example of a processing system in which at least some operations described herein can be implemented. For example, some components of the processing system 800 can be hosted on an electronic device as described in the present embodiments.

The processing system 800 can include one or more central processing units (“processors”) 802, main memory 806, non-volatile memory 810, network adapter 812 (e.g., network interface), video display 818, input/output devices 820, control device 822 (e.g., keyboard and pointing devices), drive unit 824 including a non-transitory storage medium 826, and signal generation device 830 that are communicatively connected to a bus 816. The bus 816 is illustrated as an abstraction that represents one or more physical buses and/or point-to-point connections that are connected by appropriate bridges, adapters, or controllers. The bus 816, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1594 bus (i.e., “Firewire”).

The processing system 800 can share a similar computer processor architecture as that of a desktop computer, tablet computer, personal digital assistant (PDA), smartphone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the processing system 800.

While the main memory 806, non-volatile memory 810, and storage medium 826 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 828. The term “machine-readable medium” and “storage medium” shall also be taken to include any medium that is capable of storing, encoding, or carrying a set of instructions for execution by the processing system 800.

In general, the routines executed to implement the embodiments of the disclosure can be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in a computing device. When read and executed by the one or more processors 802, the instruction(s) cause the processing system 800 to perform operations to execute elements involving the various aspects of the disclosure.

Moreover, while embodiments have been described in the context of fully functioning computing devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 810, floppy and other removable disks, hard disk drives, optical disks (e.g., Compact Disk Read-Only Memory (CD-ROMS), Digital Versatile Disks (DVDs)), and transmission-type media such as digital and analog communication links.

The network adapter 812 enables the processing system 800 to mediate data in a network 814 with an entity that is external to the processing system 800 through any communication protocol supported by the processing system 800 and the external entity. The network adapter 812 can include a network adaptor card, a wireless network interface card, a router, an access point, a wireless router, a switch, a multilayer switch, a protocol converter, a gateway, a bridge, a bridge router, a hub, a digital media receiver, and/or a repeater.

The network adapter 812 can include a firewall that governs and/or manages permission to access/proxy data in a computer network and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall can additionally manage and/or have access to an access control list that details permissions including the access and operation rights of an object by an individual, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

The description and drawings herein are illustrative and are not to be construed as limiting. Numerous specific details are described to provide a thorough understanding of the disclosure. However, in certain instances, well-known details are not described in order to avoid obscuring the description. Further, various modifications can be made without deviating from the scope of the embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms can be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms can on occasion be used interchangeably.

Consequently, alternative language and synonyms can be used for any one or more of the terms discussed herein, and no special significance is to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only and is not intended to further limit the scope and meaning of the disclosure or of any exemplified term. Likewise, the disclosure is not limited to various embodiments given in this specification.

It is to be understood that the embodiments and variations shown and described herein are merely illustrative of the principles of this invention and that various modifications can be implemented by those skilled in the art.

1. A system comprising:
at least one hardware processor; and
at least one non-transitory memory storing instructions, which, when executed by the at least one hardware processor, cause the system to:
represent a video game element as a non-fungible token (NFT) including metadata and a first authorization token,
wherein the metadata includes attribute associated with the video game element, and
wherein the attribute is modifiable;
store the NFT in a blockchain;
provide the NFT to multiple video games configured to interact with the blockchain thereby causing the multiple video games to display a visualization associated with the NFT;
receive a request from a player of a game among the multiple video games to modify an attribute and a second authorization token;
determine whether the first authorization token and the second authorization token correspond to each other;
upon determining that the first authorization token and the second authorization token do not correspond to each other, refuse to modify the attribute;
upon determining that the first authorization token and the second authorization token correspond to each other, modify the attribute by modifying the NFT; and
cause the multiple video games to update the visualization associated with the NFT based on the modified attribute upon determining that the first authorization token and the second authorization token correspond to each other.

2. The system of claim 1, comprising instructions to:
obtain multiple identifiers indicating multiple entities authorized to modify the NFT,
wherein the multiple identifiers include multiple public cryptographic keys associated with the multiple entities,
wherein the first authorization token includes the multiple identifiers;
receive the second authorization token including a cryptographic signature associated with the player;
determine whether the first authorization token and the second authorization token correspond to each other by determining whether a public cryptographic key among the multiple public cryptographic keys corresponds to the cryptographic signature associated with the player; and
upon determining that the public cryptographic key corresponds to the cryptographic signature associated with the player, authenticate the player.

3. The system of claim 1, wherein the video game element comprises a video game character, and wherein the instructions comprise instructions to:
receive an indication that the video game character has died in a first video game among the multiple video games; and
modify the NFT to indicate that the video game character has died; and
cause a second game among the multiple video games to indicate that the video game character is dead.

4. The system of claim 1, wherein the video game element comprises video game land, and wherein the instructions comprise instructions to:
receive an indication that a user in a first game purchased a second NFT from a non-fungible token marketplace,
wherein the second NFT modifies the NFT;
modify the NFT based on the second NFT; and
cause a second game among the multiple video games to display a visualization associated with the second NFT.

5. The system of claim 1, comprising instructions to:
upon determining that the first authorization token and the second authorization token correspond to each other, determine a time associated with modifying the NFT; and
based on the time, create a timestamp associated with modifying the NFT.

6. The system of claim 1, wherein the first authorization token comprises a password, and wherein the instructions to determine whether the first authorization token and the second authorization token correspond to each other comprise instructions to:
determine whether the second authorization token matches the password.

7. The system of claim 1, comprising instructions to:
obtain multiple identifiers indicating multiple entities authorized to modify the NFT;
receive the second authorization token including a cryptographic signature associated with the player;
determine whether the first authorization token and the second authorization token correspond to each other by determining whether an identifier among the multiple identifiers corresponds to the cryptographic signature associated with the player; and
upon determining that the identifier corresponds to the cryptographic signature associated with the player, authenticate the player.

8. A method comprising:
representing a virtual element as an NFT including metadata and a first authorization token,
wherein the metadata includes attribute associated with the virtual element, and
wherein the attribute is modifiable;
storing the NFT in a blockchain;
providing the NFT to multiple software platforms configured to interact with the blockchain thereby causing the multiple software platforms to display a visualization associated with the NFT;
receiving a request to modify an attribute and a second authorization token;
determining whether the first authorization token and the second authorization token correspond to each other; and
depending on whether the first authorization token and the second authorization token correspond to each other, selectively performing:
refusing to modify the attribute among the attribute; or
modifying the attribute by modifying the NFT, and
causing the multiple software platforms to update the visualization associated with the NFT based on the modified attribute.

9. The method of claim 8, comprising:
upon determining that the first authorization token and the second authorization token correspond to each other, determining a time associated with modifying the NFT; and
based on the time creating a timestamp associated with modifying the NFT.

10. The method of claim 8, wherein the virtual element comprises a virtual character, the method comprising:
receiving an indication that the virtual character has died in a first software platform among the multiple software platforms;
modifying the NFT to indicate that the virtual character has died; and
causing a second software platform among the multiple software platforms to indicate that the virtual character is dead.

11. The method of claim 8, wherein the virtual element comprises virtual land, the method comprising:
receiving an indication that a first user associated with a first software platform purchased a second NFT from an NFT marketplace,
wherein the second NFT modifies the NFT;
modifying the NFT based on the second NFT; and
causing a second software platform among the multiple software platforms to display a visualization associated with the second NFT.

12. The method of claim 8, wherein the first authorization token comprises a password, and wherein determining whether the first authorization token and the second authorization token correspond to each other comprises:
determining whether the second authorization token matches the password.

13. The method of claim 8, comprising:
obtaining multiple identifiers indicating multiple entities authorized to modify the NFT,
wherein the multiple identifiers include multiple public cryptographic keys associated with the multiple entities,
wherein the first authorization token includes the multiple identifiers;
receiving the second authorization token including a cryptographic signature associated with a user associated with the request;
determining whether the first authorization token and the second authorization token correspond to each other by determining whether a public cryptographic key among the multiple public cryptographic keys corresponds to the cryptographic signature associated with a user associated with the request; and
upon determining that the public cryptographic key corresponds to the cryptographic signature associated with the user, authenticating the user.

14. The method of claim 8, comprising:
obtaining multiple identifiers indicating multiple entities authorized to modify the NFT;
receiving the second authorization token including a cryptographic signature associated with a user associated with the request;
determining whether the first authorization token and the second authorization token correspond to each other by determining whether an identifier among the multiple identifiers corresponds to the cryptographic signature associated with the user; and
upon determining that the identifier corresponds to the cryptographic signature associated with the user, authenticating the user.

15. At least one non-transitory, computer-readable storage medium storing instructions, which, when executed by at least one data processor of a system, cause the system to:
represent a virtual element as an NFT including metadata and a first authorization token,
wherein the metadata includes attribute associated with the virtual element, and
wherein the attribute is modifiable;
store the NFT in a blockchain;
provide the NFT to multiple software platforms configured to interact with the blockchain thereby causing the multiple software platforms to display a modification associated with the NFT;
receive a request to modify an attribute and a second authorization token;
determine whether the first authorization token and the second authorization token correspond to each other;
upon determining that the first authorization token and the second authorization token do not correspond to each other, refuse to modify the attribute among the attribute;
upon determining that the first authorization token and the second authorization token correspond to each other, modify the attribute by modifying the NFT; and
cause the multiple software platforms to update the modification associated with the NFT based on the modified attribute.

16. The at least one non-transitory, computer-readable storage medium of claim 15, comprising instructions to:
upon determining that the first authorization token and the second authorization token correspond to each other, determine a time associated with modifying the NFT; and
based on the time, create a timestamp associated with modifying the NFT.

17. The at least one non-transitory, computer-readable storage medium of claim 15, wherein the virtual element comprises a virtual character, and wherein the instructions comprise instructions to:
receive an indication that the virtual character has died in a first software platform among the multiple software platforms;
modify the NFT to indicate that the virtual character has died; and
cause a second software platform among the multiple software platforms to indicate that the virtual character is dead.

18. The at least one non-transitory, computer-readable storage medium of claim 15, wherein the virtual element comprises virtual land, and wherein the instructions comprise instructions to:
receive an indication that a user in a first software platform purchased a second NFT from an NFT marketplace,
wherein the second NFT modifies the NFT;
modify the NFT based on the second NFT; and
cause a second software platform among the multiple software platforms to display a second modification associated with the second NFT.

19. The at least one non-transitory, computer-readable storage medium of claim 15, wherein the first authorization token comprises a password, and wherein the instructions to determine whether the first authorization token and the second authorization token correspond to each other comprise instructions to:
determine whether the second authorization token matches the password.

20. The at least one non-transitory, computer-readable storage medium of claim 15, comprising instructions to:
obtain multiple identifiers indicating multiple entities authorized to modify the NFT,
wherein the multiple identifiers include multiple public cryptographic keys associated with the multiple entities,
wherein the first authorization token includes the multiple identifiers;
receive the second authorization token including a cryptographic signature associated with a user associated with the request;
determine whether the first authorization token and the second authorization token correspond to each other by determining whether a public cryptographic key among the multiple public cryptographic keys corresponds to the cryptographic signature associated with the user; and
upon determining that the public cryptographic key corresponds to the cryptographic signature associated with the user, authenticate the user.

21. The at least one non-transitory, computer-readable storage medium of claim 15, comprising instructions to:
obtain multiple identifiers indicating multiple entities authorized to modify the NFT;
receive the second authorization token including a cryptographic signature associated with a user associated with the request;
determine whether the first authorization token and the second authorization token correspond to each other by determining whether an identifier among the multiple identifiers corresponds to the cryptographic signature associated with the user; and
upon determining that the identifier corresponds to the cryptographic signature associated with the user, authenticate the user.

22. A system comprising:
at least one hardware processor; and
at least one non-transitory memory storing instructions, which, when executed by the at least one hardware processor, cause the system to:
represent a video game element as a non-fungible token (NFT) including metadata and a first authorization token,
wherein the metadata includes attribute associated with the video game element, and
wherein the attribute is modifiable;
store the NFT in a blockchain;
provide the NFT to multiple video games configured to interact with the blockchain thereby causing the multiple video games to generate a modification associated with the NFT;
receive a request associated with a game among the multiple video games to modify an attribute and a second authorization token;
determine whether the first authorization token and the second authorization token correspond to each other;
upon determining that the first authorization token and the second authorization token do not correspond to each other, refuse to modify the attribute; and
upon determining that the first authorization token and the second authorization token correspond to each other, modify the attribute by modifying the NFT.

23. The system of claim 22, wherein the modification associated with the NFT causes a visual modification, an audio modification, a haptic modification, an olfactory modification, or a taste modification.
